(19) United States
(12) Patent Application Publication
(10) Pub. No.: US 2018/0186663 A1
(43) Pub. Date: Jul. 5, 2018

(54) WATER TREATMENT APPARATUS USING REVERSE OSMOSIS

(71) Applicant: Korea University Research and Business Foundation, Seoul (KR)

(72) Inventors: Seung-Kwan HONG, Yongin-si (KR); Jung-Bin KIM, Seoul (KR)

(73) Assignee: Korea University Research and Business Foundation, Seoul (KR)

(21) Appl. No.: 15/819,812

(22) Filed: Nov. 21, 2017

(30) Foreign Application Priority Data
Dec. 29, 2016 (KR) 10-2016-0182538

(51) Int. Cl. C02F 1/44; B01D 61/02

(52) U.S. Cl. CPC C02F 1/441; B01D 61/022; C02F 2301/046; C02F 2301/022; C02F 2201/007

(57) ABSTRACT

Disclosed is a water treatment apparatus using reverse osmosis including: a PV module including a plurality of reverse osmosis modules arranged at multiple stages and connected to one another such that concentrate of one stage is fed to the following stage; a raw water supply pump feeding raw water to the PV module; a circulation pipe returning product water processed by several reverse osmosis modules disposed at rear stages of the PV module, to be mixed with the raw water; and a product water discharge pipe discharging product water processed by the remaining reverse osmosis modules disposed at front stages of the PV module, out of the PV module. The water treatment apparatus can reduce the TDS concentrations of product water and raw water while minimizing the volume loss of product water by returning a portion of the product water processed by the PV module to be circulated.

### CROSS REFERENCE TO RELATED APPLICATION

The present application claims priority to Korean Patent Application No. 10-2016-0182538, filed Dec. 29, 2016, the entire contents of which is incorporated herein for all purposes by this reference.

### BACKGROUND OF THE PRESENT INVENTION

### Field of the Present Invention

The present invention relates to a water treatment apparatus using reverse osmosis. More particularly, the present invention relates to a water treatment apparatus using reverse osmosis capable of returning a portion of product water produced by a pressure vessel (PV) module composed of a plurality of reverse osmosis modules to be mixed with raw water, thereby minimizing quantitative loss of the product water, and lowering concentration of the product water, furthermore lowering concentration of the raw water which results in reduction of a hydraulic pressure required to achieve a target recovery rate of the PV module.

### Description of the Related Art

The problem of global water shortage has been intensified in recent years. Most of the water (over 97%) on earth is salt water that comes from the world oceans and seas and the remainder constitutes fresh water. However, of the fresh water, only a small portion is usable by humans. Therefore, the amount of usable water is insufficient to meet our demand for drinking water and domestic use. Moreover, ongoing climate change, desertification, and water pollution are worsening this situation. For example, in 2015, the National Intelligence Council (NIC) reported that over 3 billion people, which is over half of the world population, were estimated to live in countries that will suffer from water shortage in near future. In addition, the World Meteorological Organization (WMO) estimates that 653 to 904 million people are expected to experience water shortage by 2025 and 2.43 billion of people by 2050.

In an effort to address this water shortage problem, various approaches, for example, use of filtrate of lake water or river water, water withdrawal from underground, and artificial rainfall capture have been suggested. However, seawater desalination is currently considered as the most fundamental and practical solution.

Seawater desalination or brine desalination (hereinafter, collectively referred to as ‘seawater desalination’) is a process of removing dissolved salts from seawater to produce fresh water for consumption. There are two major types of desalination technologies, one is thermal-based desalination and the other is membrane-based desalination. The former technology involves evaporation of seawater, whereas the latter technology uses water permeability and salt selectivity of a membrane. Membrane desalination is mainly achieved through nanofiltration, reverse osmosis, or forward osmosis.

A water treatment method based on reverse osmosis desalination is a process of extracting fresh water by applying a hydraulic pressure higher than an osmotic pressure to a seawater section disposed on one side of a membrane. This method is currently widely used due to advantages of less energy consumption and easier operation than a water treatment method based on evaporation distillation.

In a polymer membrane process for separation and refining of seawater, separating seawater into water and salts occurs with a hydraulic pressure higher than an osmotic pressure attributable to components dissolved in seawater. The concentration of salts in seawater usually ranges from 30,000 to 45,000 ppm, and an osmotic pressure of this solution concentration is about 20 to 30 atm. That is, a hydraulic pressure of over 20 atm is required to obtain a small amount of fresh water from seawater.

The hydraulic pressure applied to a reverse osmosis membrane decreases with the decreasing total dissolved solids (TDS) concentration of seawater, i.e. raw water, fed to a reverse osmosis membrane of a water treatment system. That is, it is preferable to reduce the TDS concentration of raw water in terms of reduction of the hydraulic pressure applied to a reverse osmosis membrane. For example, Japanese Patent Application Publication No. 2007-125493 discloses a technology concerning a water purification apparatus and a control method, therefore the apparatus and method returning a portion of product water processed by a reverse osmosis membrane to be mixed with raw water.

Meanwhile, a PV accommodating a plurality of reverse osmosis modules connected to one another such that concentrate of one reverse osmosis module of the reverse osmosis modules is fed to the following reverse osmosis module is widely used. For example, Korean Patent No. 10-1551166 discloses a batch type reverse osmosis system equipped with a multistage membrane in a PV.

A water treatment apparatus using a plurality of reverse osmosis modules has an advantage of increasing a recovery rate for product water but is disadvantageous in that the overall TDS concentration of product water processed by all of the reverse osmosis modules is deteriorated because the TDS concentration of product water processed by each reverse osmosis module increases with stages disposed closer to the rear end of the apparatus. Therefore, this apparatus and method require an additional polishing step following the reverse osmosis process. For example, an additional reverse osmosis process needs to be performed as the polishing step, thereby increasing total facility costs.

The foregoing is intended merely to aid in the understanding of the background of the present invention, and is not intended to mean that the present invention falls within the purview of the related art that is already known to those skilled in the art.

### SUMMARY OF THE PRESENT INVENTION

Accordingly, the present invention has been made keeping in mind the above problems occurring in the related art, and an objective of the present invention is to provide a water treatment apparatus using reverse osmosis capable of returning product water produced by several rear-stage reverse osmosis modules of a PV module to be mixed with raw water, thereby lowering the TDS concentration of the raw water, which results in reduction in the TDS concentration of final product water while minimizing the volume loss of overall product water, and reduces a hydraulic pressure required to achieve a target recovery rate of the PV module.

In order to accomplish the above objective, the present invention provides a water treatment apparatus using reverse osmosis including: a PV module including a plurality of reverse osmosis modules arranged in multiple stages and connected to one another such that concentrate of one reverse osmosis module is fed to the following-stage reverse osmosis module as inflow water; a raw water supply pump that feeds raw water to the PV module; a circulation pipe that returns product water processed by several reverse osmosis modules disposed at rear stages of the PV module, to be mixed with the raw water that is fed to the PV module; and a product water discharge pipe that discharges product water processed by the remaining reverse osmosis modules disposed at front stages of the PV module.

The number of the reverse osmosis modules connected to the product water discharge pipe may be greater than the number of the reverse osmosis modules connected to the circulation pipe.

According to another aspect of the present invention, there is provided a water treatment apparatus using reverse osmosis including: a first PV module including a plurality of first reverse osmosis modules arranged in multiple stages and connected to one another such that concentration of one first reverse osmosis module is fed to the following-stage first reverse osmosis module; a second PV module including a plurality of second reverse osmosis modules arranged in multiple stages and connected to one another such that concentrate of one second reverse osmosis module is fed to the following-stage second reverse osmosis module; a first raw water supply pump that feeds raw water to the first PV module; a second raw water supply pump that feeds raw water to the second PV module; a first circulation pipe that returns product water processed by several first reverse osmosis modules disposed at rear stages of the first PV module, among the plurality of first reverse osmosis modules of the first PV module, to be mixed with the raw water fed to the second PV module; a first product water discharge pipe that discharges product water processed by the remaining first reverse osmosis modules disposed at front stages of the first PV module; a second circulation pipe that returns product water processed by several second reverse osmosis modules disposed at rear stages of the second PV module, among the plurality of second reverse osmosis modules of the second PV module, to be mixed with the raw water fed to the first PV module; and a second product water discharge pipe that discharges product water processed by the remaining second reverse osmosis modules disposed at front stages of the second PV module.

A front end portion of the first PV module and a rear end portion of the second PV module may be disposed close to each other, and a rear end portion of the first PV module and a front end portion of the second PV module are disposed close to each other.

The number of the first reverse osmosis modules connected to the first product water discharge pipe may be greater than the number of the first reverse osmosis modules connected to the first circulation pipe, and the number of the second reverse osmosis modules connected to the second product water discharge pipe may be greater than the number of the second reverse osmosis modules connected to the second circulation pipe.

The first PV module and the second PV module may constitute a PV unit, and a plurality of the PV units may constitute a PV train.

According to the present invention, the water treatment apparatus using reverse osmosis is structured such that the product water processed by only some reverse osmosis modules disposed at front stages of a PV module is discharged out of the PV module as final product water. Therefore, the water treatment apparatus using reverse osmosis can produce the final product water with a TDS concentration lower than that of product water produced by a conventional complete PV module. That is, since product water that is processed by several rear-stage reverse osmosis modules of the PV module and has a relatively high TDS concentration in comparison with the product water processed by the remaining reverse osmosis modules (front-stage reverse osmosis modules) of the PV module, is returned to be mixed with raw water, the quality of the final product water produced by the water treatment apparatus can be improved.

In addition, since the product water processed by the several rear-stage reverse osmosis modules, which is with a TDS concentration significantly lower than that of the raw water, is returned to be mixed with the raw water, the TDS concentration of the raw water is reduced. Therefore, a hydraulic pressure required to achieve a target recovery rate for a reverse osmosis module is reduced.

Furthermore, since an osmotic pressure increase is reduced due to dilution of inflow water introduced into the PV module, a uniform water flux can be obtained. That is, the water fluxes of the reverse osmosis modules of the PV module are more uniform. The uniform water flux leads to an increase in the amount of product water produced by the rear-stage reverse osmosis modules and reduces burden to the front-stage reverse osmosis modules. Moreover, it is possible to reduce fouling attributable to a high flux in front-stage reverse osmosis modules. Yet furthermore, since the inflow water is diluted, a concentration polarization is reduced. For this reason, scaling (deposition of particles on a membrane) is also reduced in rear-stage reverse osmosis modules.

Yet furthermore, since product water discharged out of the rear-stage reverse osmosis modules is mixed with raw water before the raw water is pressurized by a raw water supply pump, it is possible to reduce energy loss attributable to entropy increase.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating the construction of a water treatment apparatus using reverse osmosis according to a first embodiment of the present invention;

FIG. 2 is a schematic view illustrating the construction of a PV module of FIG. 1;

FIGS. 3A to 5B are graphs illustrating effects of the water treatment apparatus using reverse osmosis according to the first embodiment of the present invention;

FIG. 6 is a schematic view illustrating a water treatment apparatus using reverse osmosis according to a second embodiment of the present invention; and

FIG. 7 is a schematic view illustrating the construction of a train including the water treatment apparatus using reverse osmosis according to the second embodiment of the present invention.

### DETAILED DESCRIPTION OF THE PRESENT INVENTION

Hereinbelow, exemplary embodiments of the present invention will be described in detail with reference to the accompanying drawings.

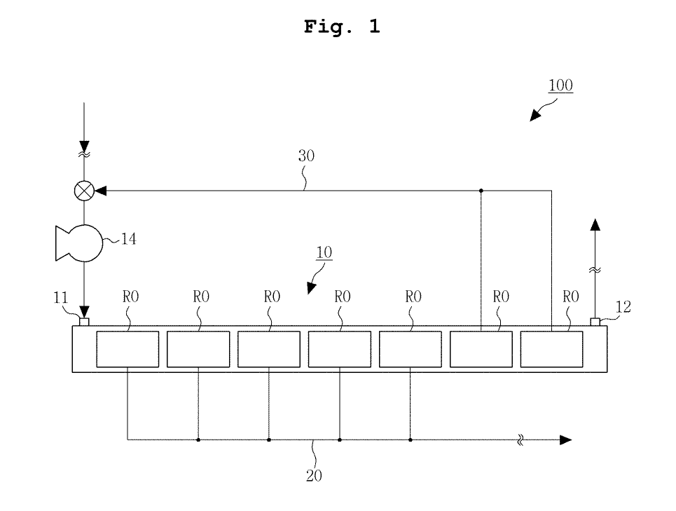

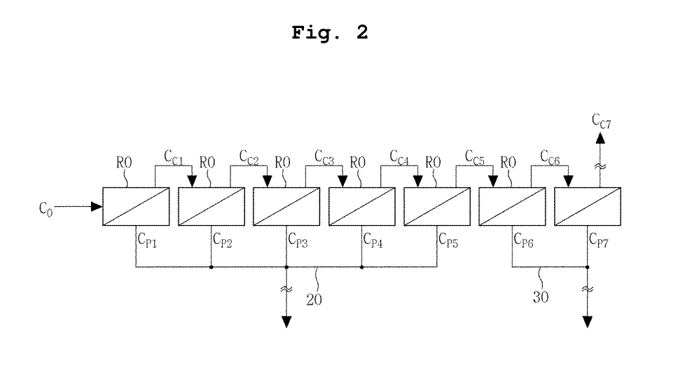

FIG. 1 is a schematic view illustrating the construction of a water treatment apparatus using reverse osmosis 100 according to a first embodiment of the present invention, and FIG. 2 is a schematic view illustrating the construction of a PV module 10 of FIG. 1. Referring to FIGS. 1 and 2, according to the first embodiment of the present invention, a water treatment apparatus 100 includes a PV module 10, a raw water supply pump 14, a circulation pipe 30, and a product water discharge pipe 20.

The PV module 10 includes a plurality of reverse osmosis modules RO arranged in multiple stages and connected to one another such that concentrate of one stage is fed to the following stage. According to the first embodiment, as illustrated in FIGS. 1 and 2, for example, the PV module 10 includes seven reverse osmosis modules.

The raw water supply pump 14 feeds raw water to the PV module 10 through an inlet 11. The raw water fed to the PV module 10 is processed through reverse osmosis by each reverse osmosis module RO of the PV module 10 and the processed water (product water) is discharged out of the PV module 10 through the product water discharge pipe 20 and the circulation pipe 30. On the other hand, concentrate discharged out of each reverse osmosis module RO is discharged out of the PV module 10 through an outlet 12.

Specifically, referring to FIG. 2, raw water fed through the inlet 11 is first supplied to a first reverse osmosis module RO disposed at the foremost stage of the PV module 10, thereby undergoing reverse osmosis in the first reverse osmosis module RO and splitting into product water and concentrate. The concentrate discharged out of the first reverse osmosis module RO is fed to a second reverse osmosis module RO. That is, the reverse osmosis modules RO are connected to one another in such a manner such that concentrate discharged out of one reverse osmosis module RO is fed, as inflow water, to the following reverse osmosis module RO, and concentrate discharged out of a reverse osmosis module disposed at the rearmost stage is discharged out of the PV module 10 through the outlet 12.

The circulation pipe 30 returns product water processed by several reverse osmosis modules RO disposed at rear stages of the PV module 10 such that the returned product water is mixed with raw water to be fed to the PV module 10. According to the first embodiment of the present invention, the circulation pipe 30 is connected to a raw water pipe connected to the upstream side of the raw water supply pump 14.

The product water discharge pipe 20 discharges product water processed by the remaining reverse osmosis modules RO disposed at front stages of the PV module 10, out of the PV module 10.

According to the present invention, as illustrated in FIGS. 1 and 2, product water processed by two reverse osmosis modules RO disposed at rear stages of the PV module 10 is returned through the circulation pipe 30 to be mixed with raw water, product water processed by the remaining five reverse osmosis modules RO is discharged as final product water of the water treatment apparatus 100. The number of the reverse osmosis modules RO producing the product water returned to be mixed with raw water is determined depending on the target production rate of final product water, the target TDS concentration of the final product water, or the like. Preferably, the number of the reverse osmosis modules RO connected to the product water discharge pipe 20 is greater than the number of the reverse osmosis modules RO connected to the circulation pipe 30.

Hereinafter, the TDS concentration of the product water processed by the PV module 10 of the water treatment apparatus 100 according to the first embodiment of the present invention, the TDS concentration of the product water returned to be mixed with raw water, and the TDS concentration of the raw water will be described with reference to FIG. 2.

Hereinafter, the TDS concentration of the raw water is denoted as C₀, the TDS concentrations of the product water processed by the respective reverse osmosis modules RO of the PV module 10 are respectively denoted as C_{P1}, C_{P2}, C_{P3}, C_{P4}, C_{P5}, C_{P6}, and C_{P7}, and the TDS concentrations of concentrate discharged from the respective reverse osmosis modules RO of the PV module 10 are respectively denoted as C_{C1}, C_{C2}, C_{C3}, C_{C4}, C_{C5}, C_{C6}, and C_{C7}. The TDS concentrations C_{P1} to C_{P7} gradually increase from C_{P1} to C_{P7} (i.e. C_{P1}<C_{P2}<C_{P3}<C_{P4}<C_{P5}<C_{P6}<C_{P7}). That is, the TDS concentration of the product water increases with decreasing distance to a rear end of the PV module 10. This is because the TDS concentration of the concentrate fed to each reverse osmosis module RO increases with decreasing distance to the rear end of the PV module 10 (i.e. C₀<C_{C1}<C_{C2}<C_{C3}<C_{C4}<C_{C5}<C_{C6}<C_{C7}).

According to the first embodiment of the present invention, the product water processed by only the reverse osmosis modules RO disposed at front stages of the PV module 10 is discharged out of the PV module 10 as final product water of the PV module 10. Therefore, the water treatment apparatus according to the present invention can produce product water with a TDS concentration lower than that of product water produced by a complete PV module of a conventional water treatment apparatus. That is, since product water with a relatively high TDS concentration, produced by the reverse osmosis modules RO disposed at rear stages of the PV module 10, is returned through the circulation pipe 30 to be mixed with raw water, the overall quality of the final product water produced by the PV module 10 is improved.

In addition, since product water with a significantly lower TDS concentration than that of raw water, which is processed by the reverse osmosis modules RO disposed at the rear stages, is returned and mixed with the raw water, the TDS concentration of the raw water is reduced. Therefore, a hydraulic pressure required to achieve a target recovery rate for a reverse osmosis module can be reduced.

Furthermore, since an osmotic pressure increase is reduced due to dilution of inflow water introduced into the PC module 10, all of the reverse osmosis modules RO constituting the PV module 10 shows a more uniform water flux. The uniform water flux leads to an increase in the amount of product water produced by the reverse osmosis modules disposed at the rear stages and thus reduces burden to the reverse osmosis modules disposed at the front stages. Moreover, it is possible to reduce fouling attributable to a high flux in the reverse osmosis modules disposed at the front stages. Yet furthermore, with the dilution of the inflow water, it is possible to reduce a concentration polarization, thereby reducing scaling occurring in the reverse osmosis modules at the rear stages.

Furthermore, since the product water processed by the reverse osmosis modules disposed at the rear stages is mixed with the raw water before the raw water is pressurized by the raw water supply pump 14, it is possible to reduce energy loss attributable to entropy increase.

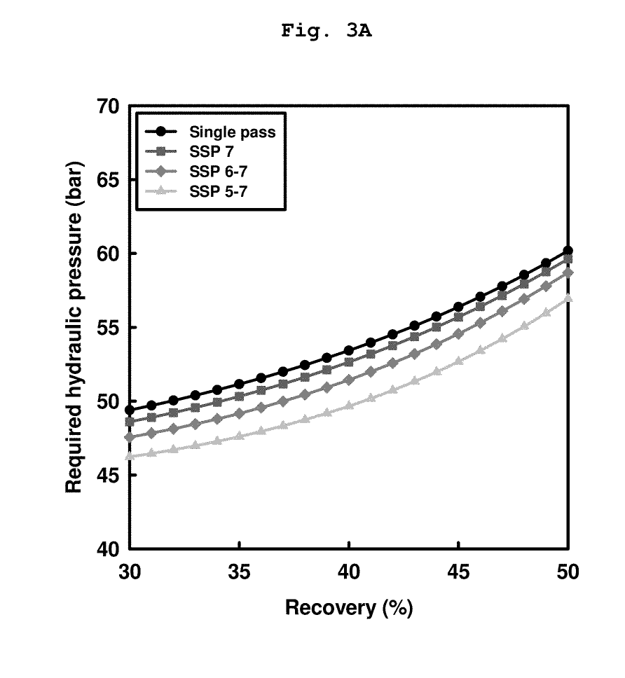

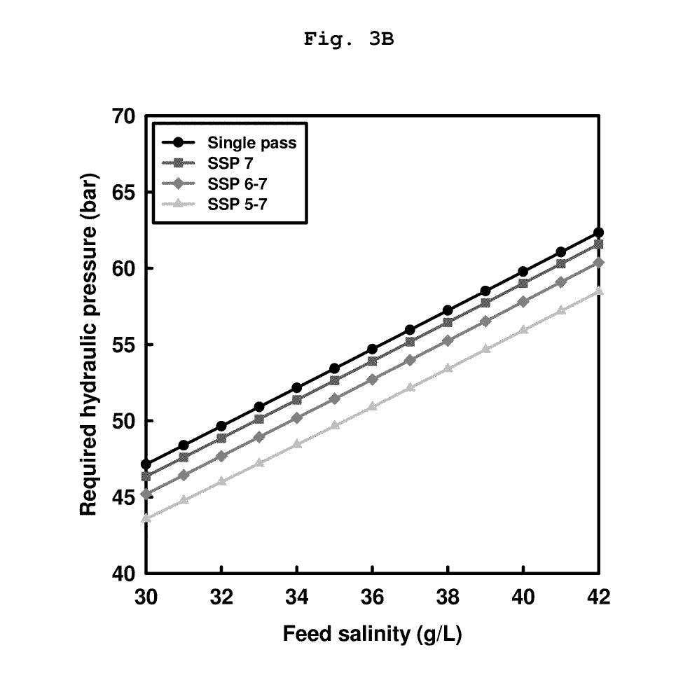

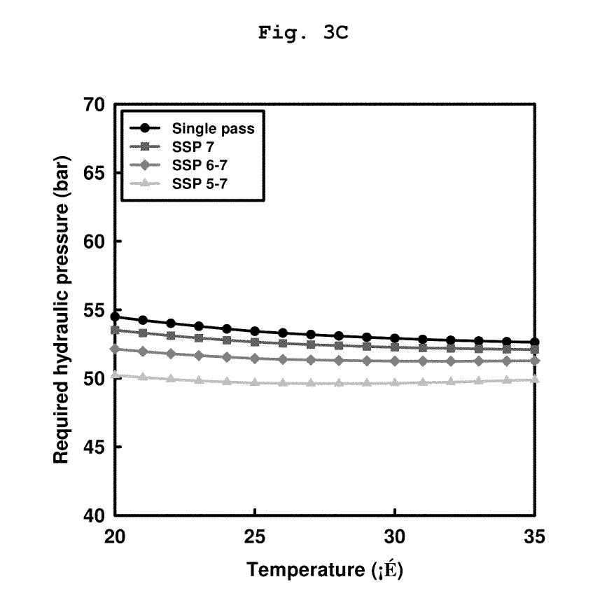

Hereinafter, effects of the water treatment apparatus 100 according to the first embodiment will be described with reference to FIGS. 3A to 5B.

FIGS. 3A to 3C are simulation results of a conventional single pass water treatment apparatus and three cases of a water treatment apparatus 100 including a total of seven reverse osmosis modules, according to the present invention, the three cases including: a first case SSP 5-7 in which product water processed by three osmosis modules RO disposed at rear stages, among the seven reverse osmosis modules RO, is returned to be mixed with raw water; a second case SSP 6-7 in which product water processed by two reverse osmosis modules disposed at rear stages, among the seven reverse osmosis modules RO, is returned to be mixed with raw water; a third case SSP 7 in which product water produced by one reverse osmosis module disposed at the rearmost stage, among the seven reverse osmosis modules, is returned to be mixed with raw water. FIG. 3A shows a relationship between a recovery rate (%) and a required hydraulic pressure (bar), FIG. 3B shows a relationship between a TDS concentration (g/L) of inflow water and a required hydraulic pressure (bar), and FIG. 3C shows a relationship between a temperature (° C.) of inflow water and a required hydraulic pressure (bar).

In FIG. 3A, the x-axis indicates a recovery rate and the y-axis indicates a hydraulic pressure. As illustrated in FIG. 3A, the conventional water treatment apparatus requires a higher hydraulic pressure for an equal recovery rate than the water treatment apparatus of the present invention. In the case SSP 5-7 in which product water processed by three reverse osmosis modules at rear stages is returned to be mixed with raw water, the lowest hydraulic pressure is required to achieve an equal recovery rate.

In FIG. 3B, the x-axis indicates a TDS concentration of inflow water and the y-axis indicates a required hydraulic pressure. As illustrated in FIG. 3B, the conventional water treatment apparatus requires the highest hydraulic pressure for an equal TDS concentration of inflow water. In the case SSP 5-7 in which product water processed by three reverse osmosis modules at rear stages is returned to be mixed with raw water, the lowest hydraulic pressure is required for an equal TDS concentration of inflow water.

In FIG. 3C, the x-axis indicates a temperature of inflow water and the y-axis indicates a required hydraulic pressure. As illustrated in FIG. 3C, the conventional water treatment apparatus requires the highest hydraulic pressure for an equal temperature of inflow. In the case SSP 5-7 in which product water processed by three reverse osmosis modules at rear stages is returned to be mixed with raw water, the lowest hydraulic pressure is required for an equal temperature of inflow water.

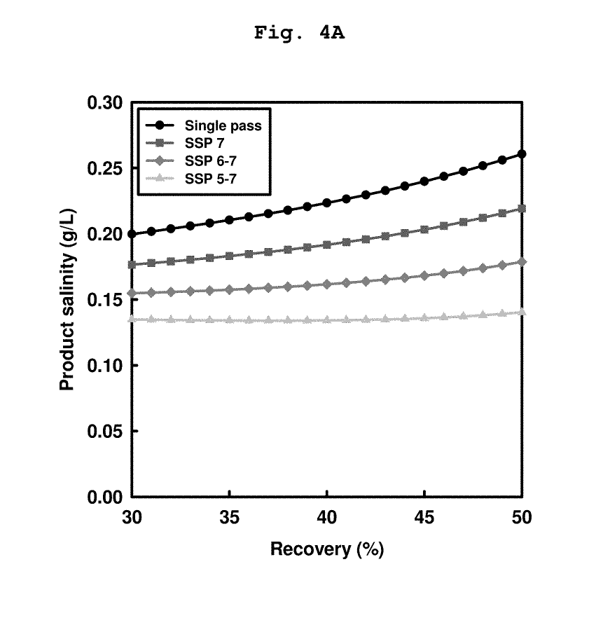

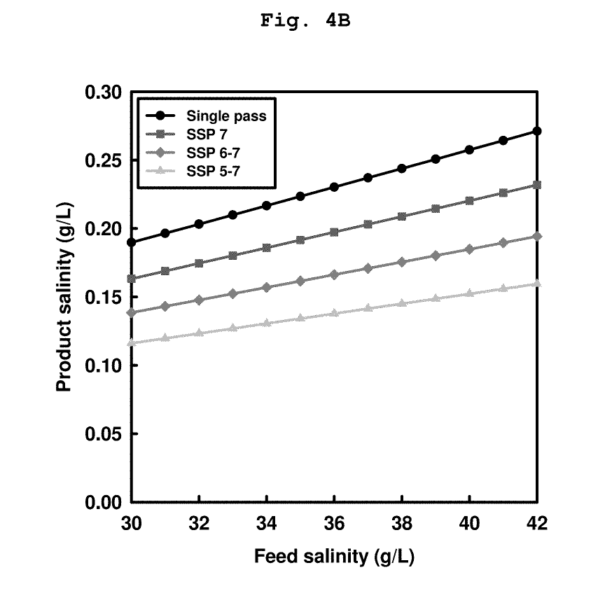

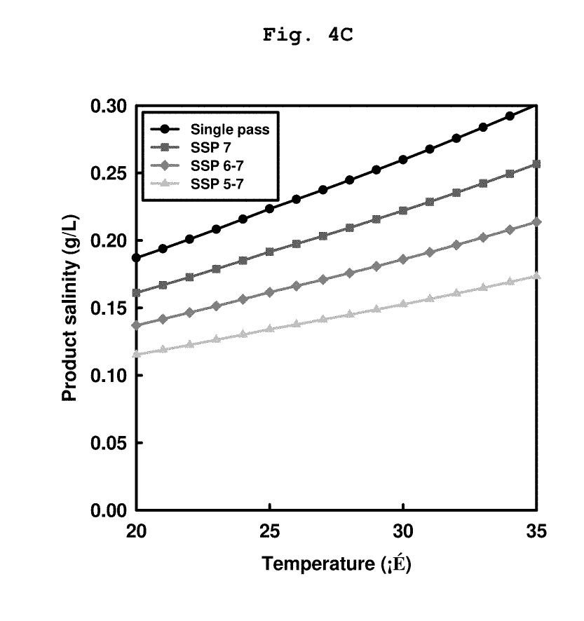

FIGS. 4A to 4C are simulation results of a conventional single pass water treatment apparatus and three cases of a water treatment apparatus 100 including a total of seven reverse osmosis modules according to the present invention, the three cases including: a first case SSP 5-7 in which product water processed by three osmosis modules RO disposed at rear stages, among the seven reverse osmosis modules RO, is returned to be mixed with raw water; a second case SSP 6-7 in which product water processed by two reverse osmosis modules disposed at rear stages, among the seven reverse osmosis modules RO, is returned to be mixed with raw water; a third case SSP 7 in which product water produced by one reverse osmosis module disposed at the rearmost stage, among the seven reverse osmosis modules, is returned to be mixed with raw water. FIG. 4A shows a relationship between a recovery rate (%) and a TDS concentration (g/L) of product water, FIG. 4B shows a relationship between a TDS concentration (g/L) of inflow water and a TDS concentration (g/L) of product water, and FIG. 3C shows a relationship between a temperature (° C.) of inflow water and a TDS concentration (g/L) of product water.

In FIG. 4A, the x-axis indicates a recovery rate and the y-axis indicates a TDS concentration of the product water. As illustrated in FIG. 4A, the conventional water treatment apparatus produces product water with a higher TDS concentration for an equal recovery rate than the water treatment apparatus of the present invention. In the case SSP 5-7 in which product water processed by three reverse osmosis modules at rear stages is returned to be mixed with raw water, product water with the lowest TDS concentration is produced.

In FIG. 4B, the x-axis indicates a TDS concentration of inflow water and the y-axis indicates a TDS concentration of product water. As illustrated in FIG. 4B, when the TDS concentration of the inflow water is fixed, the conventional water treatment apparatus produces product water with a higher TDS concentration than the water treatment apparatus of the present invention. In the case SSP 5-7 in which product water processed by three reverse osmosis modules at rear stages is returned to be mixed with raw water, product water with the lowest TDS concentration is produced.

In FIG. 4C, the x-axis indicates a temperature of inflow water and the y-axis indicates a TDS concentration of product water. As illustrated in FIG. 4C, when the temperature of the inflow water is fixed, product water produced by the conventional water treatment apparatus has a higher TDS concentration than that produced by the water treatment apparatus of the present invention. In the case SSP 5-7 in which product water processed by three reverse osmosis modules at rear stages is returned to be mixed with raw water, product water with the lowest TDS concentration is produced.

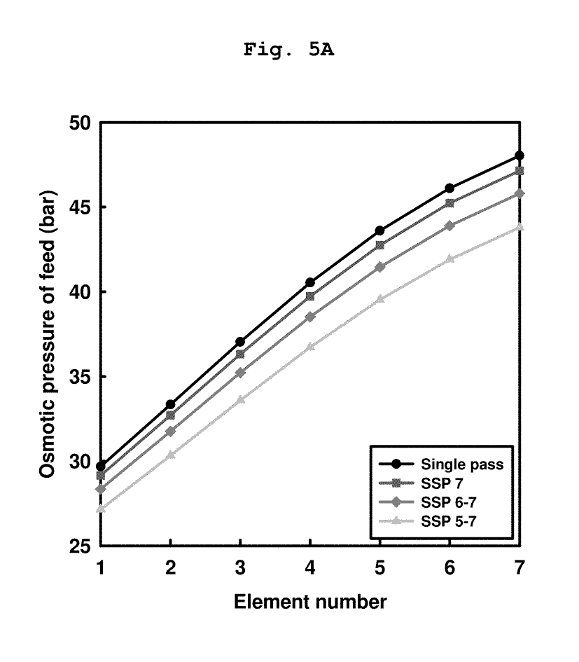

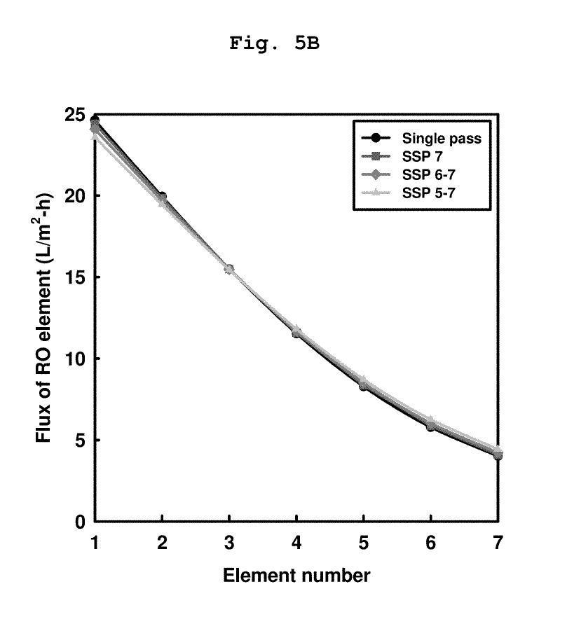

FIGS. 5A to 5B are simulation results of a conventional single pass water treatment apparatus and three cases of a water treatment apparatus 100 including a total of seven reverse osmosis modules according to the present invention, the three cases including: a first case SSP 5-7 in which product water processed by three osmosis modules RO disposed at rear stages, among the seven reverse osmosis modules RO, is returned to be mixed with raw water; a second case SSP 6-7 in which product water processed by two reverse osmosis modules disposed at rear stages, among the seven reverse osmosis modules RO, is returned to be mixed with raw water; a third case SSP 7 in which product water produced by one reverse osmosis module disposed at the rearmost stage, among the seven reverse osmosis modules, is returned to be mixed with raw water. FIG. 5A shows a relationship between osmotic pressures (bar) of inflow water passing through the reverse osmosis modules and FIG. 5B shows a relationship between water fluxes (L/m²-h) of the reverse osmosis modules.

In FIG. 5A, the x-axis indicates reverse osmosis modules sequentially arranged from the inlet and the y-axis indicates an osmotic pressure of inflow water passing through each reverse osmosis module. As illustrated in FIG. 5A, the osmotic pressure of inflow water in the water treatment apparatus of the present invention is lower than that in the conventional water treatment apparatus because inflow water is diluted. In the case SSP 5-7 in which product water processed by three reverse osmosis modules at rear stages is returned to be mixed with raw water, the osmotic pressure of inflow water is the lowest. In addition, since the inflow water is diluted, the TDS concentration of the inflow water is reduced and thus the concentration polarization is accordingly reduced. Therefore, scaling occurring in the rear-stage reverse osmosis modules can be reduced.

In FIG. 5B, the x-axis indicates reverse osmosis modules sequentially arranged from the inlet, and the y-axis indicates water flux (L/m²-h) of each reverse osmosis module. As illustrated in FIG. 5B, the water fluxes of the reverse osmosis modules are more uniform in the water treatment apparatus of the present invention than that in the conventional water treatment apparatus. In the case SSP 5-7 in which product water processed by three reverse osmosis modules at rear stages is returned to be mixed with raw water, the most uniform water flux can be obtained for an equal TDS concentration of inflow water. This uniform water flux leads to an increase in the amount of product water produced by the rear-stage reverse osmosis modules and reduces a burden to the front-stage reverse osmosis modules. Furthermore, it is possible to reduce fouling attributable to a high flux in the front-stage reverse osmosis modules.

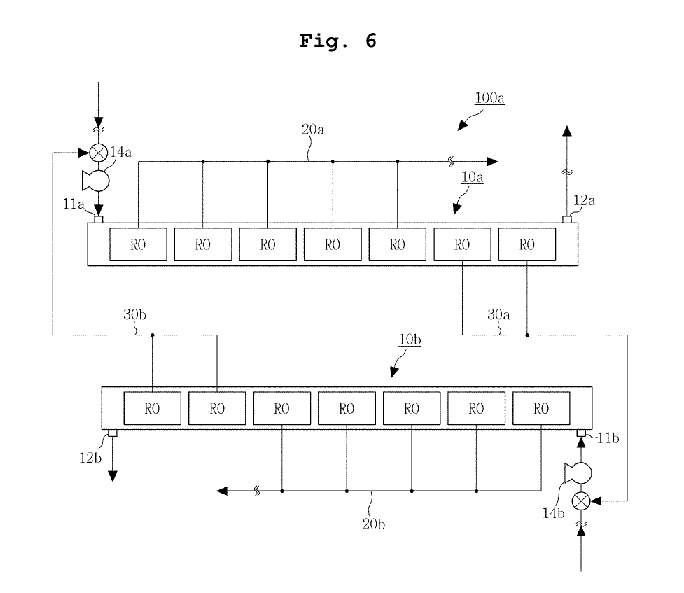

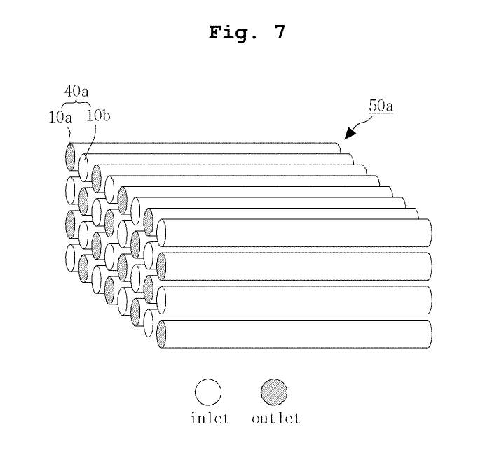

Hereinafter, a water treatment apparatus using reverse osmosis 100a according to a second embodiment of the present invention will be described with reference to FIGS. 6 and 7. The water treatment apparatus 100a according to the second embodiment of the present invention includes a first PV module 10a, a second PV module 10b, a first raw water supply pump 14a, a second raw water supply pump 14b, a first circulation pipe 30a, a second circulation pipe 30b, a first product water discharge pipe 20a, and a second product water discharge pipe 20b.

The first PV module 10a includes a plurality of first reverse osmosis modules RO arranged in multiple stages and connected to one another such that concentrate discharged out of one stage is fed to the following stage. The second PV module 10b includes a plurality of second reverse osmosis modules RO arranged in multiple stages and connected to one another such that concentrate discharged out of one stage is fed to the following stage. The constructions of the first reverse osmosis modules RO and the second reverse osmosis modules RO are similar to that of the reverse osmosis modules RO according to the first embodiment of the present invention. Therefore, a detailed description of the constructions of the first and second reverse osmosis modules will be omitted.

The first circulation pipe 30a returns product water processed by several first reverse osmosis modules disposed at rear stages of the first PV module 10a, among the plurality of first reverse osmosis modules RO of the first PV module 10a, to be mixed with raw water fed to the second PV module 10b. That is, a portion of the total product water processed by the first PV module 10a is fed to the second PV module 10b through the first circulation pipe 30a.

Similarly, the second circulation pipe 30b returns product water processed by several second reverse osmosis modules disposed at rear stages of the second PV module 10b, among the plurality of second reverse osmosis modules RO, to be mixed with raw water fed to the first PV module 10a. That is, a portion of the total product water processed by the second PV module 10b is fed to the first PV module 10a through the second circulation pipe 30b.

As illustrated in FIG. 6, a front end portion (i.e. inlet 11a) of the first PV module 10a and a rear end portion (i.e. outlet 12b) of the second PV module 10b are arranged close to each other, and a rear end portion (i.e. outlet 12a) of the first PV module 10a and a front end portion (i.e. inlet 11b) of the second PV module 10b are arranged close to each other. In this way, it is possible to minimize the lengths of the first circulation pipe 30a and the second circulation pipe 30b.

The product water discharge pipe 20a discharges product water processed by the remaining first reverse osmosis modules RO disposed at front stages of the first PV module 10a, out of the first PV module 10a, and the second product water discharge pipe 20b discharges product water processed by the remaining second reverse osmosis modules disposed at front stages of the second PV module 10b, out of the second PV module 10b.

The first PV module 10a and the second PV module 10b are arranged in reverse order. In addition, a portion of the product water processed by the first PV module 10a is returned to be mixed with the raw water fed to the second PV module 10b, and a portion of the product water processed by the second PV module 10b is returned to be mixed with the raw water fed to the first PV module 10a. Accordingly, the second embodiment can improve installation efficiency (for example, reduction in usage of pipe) while providing the same effect as the first embodiment.

FIG. 7 is a diagram illustrating the construction of a train 50a of a water treatment apparatus using reverse osmosis 100a according to the second embodiment of the present invention. According to the second embodiment, one train 50a includes a plurality of PV units 40a, and one PV unit 40a includes a first PV module 10a and a second PV module 10b. To improve pipe installation efficiency, an inlet ‘−’ and an outlet ‘+’ of respective neighboring PV modules 10a and 10b are disposed close to each other.

Since the constituent elements including the first PV module 10a and the second PV module 10b, according to the second embodiment of the present invention, are similar to those of the first embodiment, a description thereof will be omitted.

Although a preferred embodiment of the present invention has been described for illustrative purposes, those skilled in the art will appreciate that various modifications, additions and substitutions are possible, without departing from the scope and spirit of the present invention as disclosed in the accompanying claims.

What is claimed is:

1. A water treatment apparatus using reverse osmosis, the water treatment apparatus comprising:
a PV module comprising a plurality of reverse osmosis modules arranged in multiple stages and connected to one another such that concentrate of one reverse osmosis module is fed to a following-stage reverse osmosis module;
a raw water supply pump that feeds raw water to the PV module;
a circulation pipe that returns product water processed by several reverse osmosis modules disposed at rear stages of the PV module, to be mixed with raw water that is to be fed to the PV module; and
a product water discharge pipe that discharges product water processed by the remaining reverse osmosis modules disposed at front stages of the PV module, out of the PV module.

2. The water treatment apparatus according to claim 1, wherein the number of the reverse osmosis modules connected to the product water discharge pipe is greater than the number of the reverse osmosis modules connected to the circulation pipe.

3. A water treatment apparatus using reverse osmosis comprising:
a first PV module comprising a plurality of first reverse osmosis modules arranged in multiple stages and connected to one another such that concentration of one first reverse osmosis module of the first PV module is fed to a following-stage first reverse osmosis module;
a second PV module comprising a plurality of second reverse osmosis modules arranged in multiple stages and connected to one another such that concentrate of one second reverse osmosis module of the second PV module is fed to a following-stage second reverse osmosis module;
a first raw water supply pump that feeds raw water to the first PV module;
a second raw water supply pump that feeds raw water to the second PV module;
a first circulation pipe that returns product water processed by several first reverse osmosis modules disposed at rear stages of the first PV module, among the plurality of first reverse osmosis modules of the first PV module, to be mixed with raw water fed to the second PV module;
a first product water discharge pipe that discharges product water processed by the remaining first reverse osmosis modules disposed at front stages of the first PV module, out of the first PV module;
a second circulation pipe that returns product water processed by several second reverse osmosis modules disposed at rear stages of the second PV module, among the plurality of second reverse osmosis modules of the second PV module, to be mixed with raw water fed to the first PV module; and
a second product water discharge pipe that discharges product water processed by the remaining second reverse osmosis modules disposed at front stages of the second PV module, out of the second PV module.

4. The water treatment apparatus according to claim 3, wherein a front end portion of the first PV module and a rear end portion of the second PV module are disposed close to each other, and
a rear end portion of the first PV module and a front end portion of the second PV module are disposed close to each other.

5. The water treatment apparatus according to claim 3, wherein the number of the first reverse osmosis modules connected to the first product water discharge pipe is greater than the number of the first reverse osmosis modules connected to the first circulation pipe, and
the number of the second reverse osmosis modules connected to the second product water discharge pipe is greater than the number of the second reverse osmosis modules connected to the second circulation pipe.

6. The water treatment apparatus according to claim 3, wherein the first PV module and the second PV module constitute a PV unit; and
a plurality of the PV units constitutes a train.
